(19) United States
(12) Patent Application Publication
(10) Pub. No.: US 2025/0181084 A1
(43) Pub. Date: Jun. 5, 2025

(54) MASS FLOW CONTROL SYSTEM FOR POLYSILICON GRANULES

(71) Applicant: REC Silicon Inc, Moses Lake, WA (US)

(72) Inventors: Daniel S. Ohs, Moses Lake, WA (US); Matthew J. Miller, Moses Lake, WA (US)

(73) Assignee: REC Silicon Inc, Moses Lake, WA (US)

(21) Appl. No.: 18/958,364

(22) Filed: Nov. 25, 2024

Related U.S. Application Data
(60) Provisional application No. 63/605,965, filed on Dec. 4, 2023.

(51) Int. Cl. G05D 7/06; B65G 27/04; B65G 43/08; G01G 13/24

(52) U.S. Cl. CPC G05D 7/0605; B65G 27/04; B65G 43/08; G01G 13/24; B65G 2201/042; B65G 2203/0258

(57) ABSTRACT

A granular material flow control system includes a granular material supply, a discharge head in fluid communication with the granular material supply, and a pan positioned beneath the discharge head to receive granular material discharged from the discharge head, the pan comprising a first end portion and a second end portion. A flow regulator conduit is coupled to a weight sensor, the flow regulator conduit having an inlet opening and an outlet opening, the second end portion of the pan being received in the inlet opening of the flow regulator conduit. A vibratory feeder is coupled to the pan and configured to vibrate the pan to induce granular material in the pan to flow off of an edge of the second end portion into the flow regulator conduit.

### CROSS REFERENCE TO RELATED APPLICATION

The present application claims the benefit of U.S. Provisional Application No. 63/605,965, filed on Dec. 4, 2023, which is incorporated herein by reference in its entirety.

### FIELD

The present application pertains to systems and methods for controlling flow of bulk particulate materials such as granular polysilicon.

### BACKGROUND

Some industrial processes require accurate and precise flow control of bulk particulate materials through a system. However, it can be difficult to accurately determine the flow rate of a bulk particulate material, especially in processes in which flow rates are relatively low such as plug flow processes, including many processes in the manufacture of polysilicon. Accordingly, a need exists for improved systems and methods for controlling flow of bulk materials.

### SUMMARY

The present disclosure pertains to systems and methods for controlling flow of bulk materials such as polysilicon granules. In a representative example, a granular material flow control system comprises a granular material supply; a discharge head in fluid communication with the granular material supply; a pan positioned beneath the discharge head to receive granular material discharged from the discharge head, the pan comprising a first end portion and a second end portion; a flow regulator conduit coupled to a weight sensor, the flow regulator conduit having an inlet opening and an outlet opening, the second end portion of the pan being received in the inlet opening of the flow regulator conduit; and a vibratory feeder coupled to the pan and configured to vibrate the pan to induce granular material in the pan to flow off of an edge of the second end portion into the flow regulator conduit.

In any or all of the disclosed examples, the discharge head comprises an inlet and an outlet and defines a longitudinal axis, and the outlet is oriented at an angle to the longitudinal axis.

In any or all of the disclosed examples, the discharge head comprises vent passages to vent gas from the granular material.

In any or all of the disclosed examples, the discharge head comprises an internal nozzle downstream of the inlet and an internal chamber downstream of the nozzle and upstream of the outlet of the discharge head.

In any or all of the disclosed examples, the vent passages are in fluid communication with the internal chamber.

In any or all of the disclosed examples, a diameter of the internal chamber is greater than a diameter of an outlet of the internal nozzle.

In any or all of the disclosed examples, the first end portion of the pan comprises a bay that is at least partially enclosed.

In any or all of the disclosed examples, the outlet of the discharge head is oriented toward the bay of the pan.

In any or all of the disclosed examples, the flow regulator conduit comprises one or a plurality of angled interior surfaces spaced apart along a longitudinal axis of the conduit.

In any or all of the disclosed examples, the flow regulator conduit comprises a plurality of baffles that define the angled interior surfaces.

In any or all of the disclosed examples, the discharge head is coupled to a support frame, and the support frame supports a weight of the granular material in the discharge head and in the granular material supply.

In any or all of the disclosed examples, the pan, the flow regulator conduit, and the vibratory feeder are mounted inside a sealed enclosure.

In any or all of the disclosed examples, at least the outlet of the discharge head is located inside the sealed enclosure.

In any or all of the disclosed examples, the discharge head, the pan, and the flow regulator conduit define a flow path for the granular material; the granular material is granular polysilicon; and interior surfaces of the flow path comprise silicon (Si) and/or silicon carbide (SiC).

In any or all of the disclosed examples, the granular material is granular polysilicon; the granular material supply is an annealer; and the vibratory feeder controls a flow rate of granular polysilicon through the annealer.

In any or all of the disclosed examples, the system further comprises a controller in communication with the weight sensor to receive a signal from the weight sensor and control an amplitude and/or frequency of the vibratory feeder based at least in part on the signal from the weight sensor.

In another representative example, a method comprises flowing a granular material through the granular material flow control system of any of the examples described herein.

In another representative example, a silicon crystal growing system comprises the granular material flow control system of any example described herein.

In any or all of the disclosed examples, the flow regulator conduit is suspended from the weight sensor.

In any or all of the disclosed examples, the pan, the flow regulator conduit, and the vibratory feeder are mounted inside a sealed enclosure; and the weight sensor is outside the sealed enclosure.

In any or all of the disclosed examples, the flow regulator conduit is coupled to a lever arm that pivots about a fulcrum as flow increases through the flow regulator conduit; and the weight sensor is coupled to the lever arm.

In another representative example, a system comprises a granular material supply; a discharge head in fluid communication with the granular material supply; a pan positioned beneath the discharge head to receive granular material discharged from the discharge head, the pan comprising a first end portion and a second end portion; a flow regulator conduit having an inlet opening and an outlet opening, the second end portion of the pan being received in the inlet opening of the flow regulator conduit; wherein the discharge head comprises an internal nozzle downstream of the inlet and an internal chamber downstream of the nozzle and upstream of the outlet of the discharge head, and vent passages to vent gas from the granular material, the vent passages being in fluid communication with the internal chamber of the discharge head.

In another representative example, a method comprises receiving data of a mass flow rate of granular polysilicon flowing through a flow control system, the flow control system comprising a discharge head that discharges granular polysilicon into a pan and a flow regulator conduit that receives granular polysilicon from the pan, wherein the data of the mass flow rate is determined by a load cell coupled to the flow regulator conduit; determining a mass flow rate error based at least in part on the mass flow rate data and a specified mass flow rate; determining a vibration amplitude and/or a frequency command based at least in part on the mass flow rate error; and transmitting the vibration amplitude and/or frequency command to a vibratory motor of a vibratory feeder system such that the vibratory motor vibrates the pan at a specified amplitude and frequency to propel granular polysilicon through the flow control system.

In another representative example, a discharge head comprises an inlet, an outlet, an internal nozzle downstream of the inlet and an internal chamber downstream of the nozzle and upstream of the outlet of the discharge head. The discharge head further comprises vent passages to vent gas from the granular material received in the discharge head, and the vent passages are in fluid communication with the internal chamber of the discharge head.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a cross-sectional view of a representative example of a granular polysilicon flow control system in communication with an annealer system.

FIG. 2 is a cross-sectional view of a portion of the flow control system of FIG. 1 showing the discharge head and the pan.

FIG. 3 is a cross-sectional view of another portion of the flow control system of FIG. 1 showing the flow regulator.

FIG. 4 is a schematic diagram of a representative control system that can be used in combination with any of the flow control systems described herein.

FIG. 5 illustrates flow of granular polysilicon through the flow control system of FIG. 1.

FIG. 6 is a schematic diagram illustrating the flow control system of FIG. 1 incorporated into a silicon crystal growing system.

FIG. 7 is a schematic block diagram illustrating a representative computer control system for implementing the disclosed methods and control of the disclosed flow control systems.

FIG. 8 illustrates another example of a flow control system in which the flow regulator conduit is suspended from a lever arm and the weight sensor is located outside the sealed enclosure.

FIG. 9 is a perspective view of the lever arm of the system of FIG. 8.

### DETAILED DESCRIPTION

### Explanation of Terms

The following explanations of terms are provided to assist in understanding the present disclosure. For purposes of this description, certain aspects, advantages, and novel features of examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

As used herein, “e.g.” means “for example,” and “i.e.” means “that is.”

In some examples, values, procedures, or apparatus may be referred to as “lowest,” “best,” “minimum,” or the like. It will be appreciated that such descriptions are intended to indicate that a selection among many alternatives can be made, and such selections need not be better or otherwise preferable to other selections.

In the description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing dimensions, quantities of components, forces, moments, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing examples from discussed prior art, the examples numbers are not approximates unless the word “about” is recited.

Although there may be alternatives for various components, parameters, ratios, dimensions, operating conditions, etc., set forth herein, that does not mean that those alternatives are necessarily equivalent and/or perform equally well. Nor does it mean that the alternatives are listed in a preferred order unless stated otherwise.

As used herein, values and/or relationships modified by the term “substantially” mean±10% of the stated value and/or relationship. “Substantially perpendicular” means an angle of 80° to 100° relative to a reference. “Substantially parallel” means an angle of ±10° relative to a reference.

### Example 1: Polysilicon Flow Control System

Ultra-high purity polycrystalline silicon (also referred to as “polysilicon”) for the photovoltaic and semiconductor industries can be produced in a variety of ways, including by chemical vapor deposition in the Siemens process and/or by pyrolytic decomposition of silicon-bearing gas in a fluidized bed reactor. The Siemens process results in long polysilicon rods that are then broken into small chunks or granules for further processing. Fluidized bed reactors can be controlled to produce polysilicon granules having a selected size distribution. As used herein, the terms “polysilicon granules” and “granular polysilicon” refer to polysilicon particulates that are produced in a fluidized bed reactor as well as to chunks of polysilicon broken from a rod formed by the Siemens process.

In some examples the polysilicon granules undergo further processing after formation by the Siemens process or in a fluidized bed reactor. For example, the polysilicon can undergo heat treatment in an annealing process. Where monocrystalline silicon is specified, such as for semiconductor wafers and/or photovoltaic cells, polysilicon granules can be melted in a crucible and drawn into single-crystal boules (also referred to as “ingots”) using, for example, the Czochralski process.

The present disclosure provides systems and methods for precisely and accurately controlling the flow rate of bulk particulate materials such as granular polysilicon through an industrial process. The disclosed flow control systems include a discharge head that is in fluid communication with a granular material supply (also referred to as a “granular material source”), such as a granular polysilicon supply (e.g., an annealer, a fluidized bed reactor, a container or canister, etc.). The discharge head can include ports that communicate between the interior of the discharge head and the surrounding environment to vent gases present in the granular material and prevent pressure from building up inside the discharge head. The discharge head can also include an outlet that is oriented at an angle (e.g., to the side) relative to the direction of flow of granular material into the discharge head. The flow control system can include a pan positioned beneath the discharge head to receive granular material from the discharge head. A vibratory feeder system can vibrate the pan to cause the granular material to flow toward a flow regulator conduit. The flow regulator conduit can include a plurality of internal, alternatingly angled surfaces. Granular material can flow from the pan into the flow regulator conduit, and can cascade through the flow regulator conduit by dropping from one angled internal surface to the next and so on to an outlet. The flow regulator conduit can be supported by a weight sensor such as a load cell. The angled interior surfaces of the flow regulator can increase the time required for granular material to flow through the flow regulator. This can increase the mass of material present in the flow regulator at any given time, thereby improving the ability to sense and control relatively low mass flow rates.

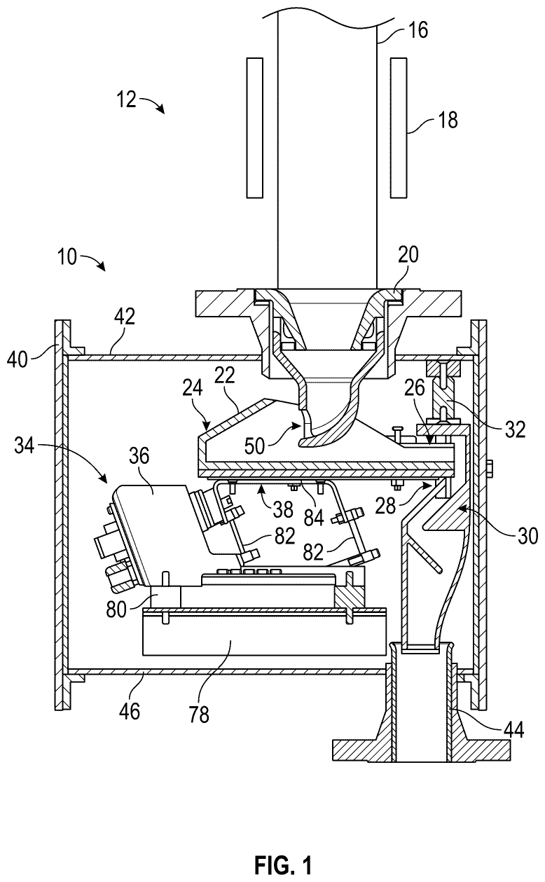

FIG. 1 illustrates a representative example of a granular material flow control system 10 configured to control the flow of granular polysilicon through a treatment process at a specified flow rate. For purposes of this example, the flow control system 10 is shown downstream of an annealing system 12 (also referred to as an “annealer”) in which polysilicon granules 14 (FIG. 5) undergo a heat treatment process. The annealing system 12 can comprise a conduit 16 such as a pipe or tube surrounded by heaters 18. The conduit 16 is oriented vertically such that flow of polysilicon through the annealer 12 is gravity-induced. In FIG. 1 the flow control system 10 is shown without granular polysilicon 14, and flow of granular polysilicon is shown in FIG. 5.

The flow control system 10 can be positioned at the outlet of the conduit 16 of the annealer 12. The flow control system 10 can comprise a discharge head 20 downstream of the conduit 16, and a container referred to herein as a “pan” 22 downstream of the discharge head 20. The pan 22 can comprise a first end portion 24 and a second end portion 26. The second end portion 26 of the pan 22 can be positioned in an inlet opening 28 of a flow regulator conduit (also referred to as a “restrictor”) 30. The flow regulator conduit 30 can be supported by a load cell 32 or other force transducer or weight sensor. In the illustrated example, the flow regulator conduit 30 is suspended from the load cell 32, although in other examples the load cell can be beneath the flow regulator conduit. A vibratory feeder (also referred to as a “vibratory feeder system” and an “agitator system”) generally indicated at 34 can be positioned beneath the pan 22. The vibratory feeder 34 can comprise a vibratory motor 36 and can transmit vibration to the pan 22 through a linkage 38 in contact with the pan 22.

The flow control system 10 can be at least partially contained in a sealed enclosure 40 (also referred to as a “sealed vessel”). For example, in the illustrated configuration the pan 22, the flow regulator conduit 30, the load cell 32 and its corresponding mount, and the vibrator feeder 34 can be wholly contained within the sealed enclosure 40. The discharge head 20 can extend through a top wall 42 of the sealed enclosure 40 such that an outlet 50 of the discharge head 20 is located inside the sealed enclosure 40. The flow regulator conduit 30 can be in fluid communication with an outlet conduit 44 that can extend through the bottom wall 46 of the sealed enclosure 40. Together the discharge head 20, the pan 22, and the flow regulator conduit 30 can at least partially define a flow path through the flow control system 10.

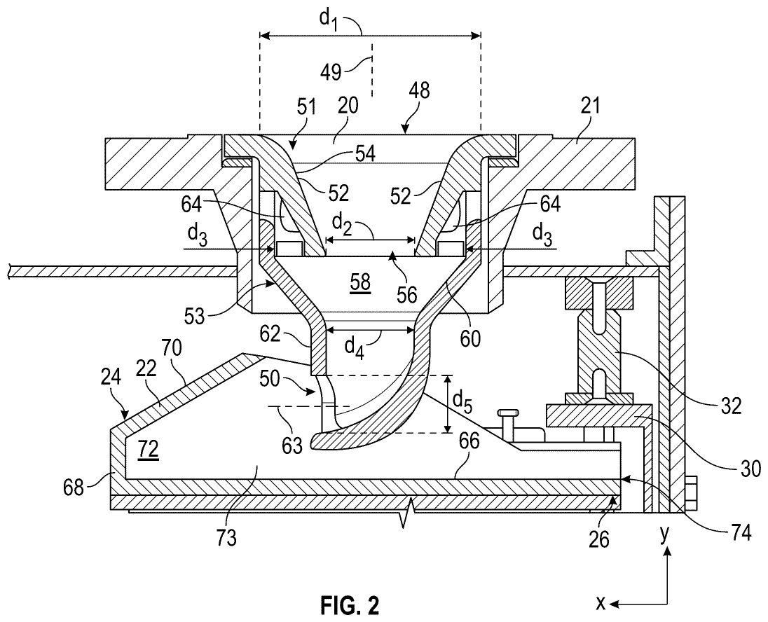

FIG. 2 illustrates the discharge head 20 in greater detail. The discharge head 20 can comprise an inlet 48 and an outlet 50, and can define a longitudinal axis 49 oriented generally in the direction of gravity (e.g., along the y-axis). The discharge head 20 can comprise a first portion 51 (also referred to as an “upper portion”) and a second portion 53 (also referred to as a “lower portion”). Downstream of the inlet 48, walls 52 of the upper portion 51 of the discharge head 20 can converge to form an internal nozzle 54. The walls 52 can begin to converge at or near the inlet 48 such that the inlet of the nozzle 54 coincides or substantially coincides with the inlet 48 of the discharge head 20. The internal nozzle 54 can have an outlet 56 that empties into an internal chamber 58 that is at least partially defined by the second portion 53 of the discharge head 20, and which is downstream of the internal nozzle 54. Walls 60 of the chamber 58 can also converge toward a tubular chute 62 downstream of the chamber 58. The chute 62 can lead to the outlet 50 of the discharge head 20. In the illustrated example the outlet 50 of the discharge head 20 is defined in the side of the discharge head (e.g., at an angle to the longitudinal axis 49). Thus, the lower wall or floor of the chute 62 can be curved to direct material toward the outlet 50.

In the illustrated example a longitudinal axis 63 of the outlet 50 can form a 90° angle with the longitudinal axis 49 of the discharge head 20 (that is, the outlet 50 can be perpendicular to the axis 49), although the outlet 50 can also be oriented upwardly (e.g., at an angle of 45° to 89° relative to the axis 49) or downwardly (e.g., at an angle of 91° to 135° to the axis 49).

As noted above, the internal diameter of the discharge head 20 can change in the direction of flow through the discharge head. For example, the inlet 48 can have a first diameter d₁, which can decrease to a second diameter d₂ at the outlet 56 of the nozzle 54 that is less than the first diameter d₁. The diameter can increase again (e.g., in a stepwise manner) to a third diameter d₃ at the upper part of the chamber 58. In some examples the third diameter d₃ can be equal or substantially equal to the first diameter d₁ at the inlet 48. The diameter can decrease again to a fourth diameter d₄ at the chute 62. In some examples the fourth diameter d₄ can be equal or substantially equal to the second diameter d₂ at the outlet 56 of the nozzle 54. The outlet 50 can have a fifth diameter d₅, which in the illustrated example is smaller than the diameter d₄ of the chute, but can be larger, smaller, or equal to the diameter d₄ depending upon the particular flow characteristics sought. Due to the internal diameter changes along the flow direction, the first and second portions 51, 53 of the discharge head 20 can resemble a first funnel positioned within a second funnel.

In certain examples, the discharge head 20 can define one or a plurality of vent passages to facilitate venting of gas entrained in the granular material flow. For example, at the location of the stepwise diameter increase between the outlet 56 of the nozzle 54 and the chamber 58 the discharge head 20 can define one or a plurality of vent passages 64. The vent passages 64 can communicate between the chamber 58 and the interior of the sealed enclosure 40 and/or the environment outside the enclosure 40 depending upon the particular requirements of the system.

The discharge head 20 can be received within and supported by a frame 21 or other support structure. In some examples the vent passages 64 can be in fluid communication with an interior of the support frame 21.

Turning now to the pan 22, the pan 22 can comprise a lower surface (also referred to as a floor) 66, and the outlet 50 of the discharge head 20 can be positioned above the floor 66. The first end portion 24 of the pan 22 can comprise a rear wall 68 and a top wall 70 (also referred to as a cover). The top wall 70 can slope upwardly away from the rear wall 68 toward the discharge head 20 such that the first end portion 24 forms a cavity 72 (also referred to as a recess, a pocket, and a bay) that is open at the top and at least partly enclosed on the sides by side walls 73 and the rear wall 68. An edge 74 of the second end portion 26 is shown disposed within the flow regulator conduit 30.

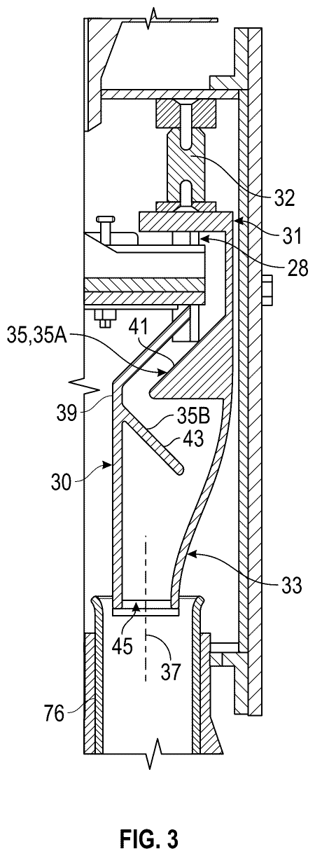

FIG. 3 illustrates the flow regulator conduit 30 in greater detail. The flow regulator conduit 30 can be configured as a tubular body and oriented generally along the y-axis in the direction of gravity. The flow regulator conduit 30 can comprise a first end portion 31 and a second end portion 33. The first end portion 31 can define the inlet opening 28. The flow regulator conduit 30 can define one or a plurality of sloped interior surfaces 35 that are angled relative to the longitudinal axis 37 of the flow regulator conduit. In some examples the sloped interior surfaces 35 can be the surfaces of baffles or flanges extending from the side walls 39 of the flow regulator conduit 30 into the flow path and arranged in an alternating fashion. For example the flow regulator conduit 30 illustrated in FIG. 3 includes a baffle 41 positioned below the inlet opening 28 and defining a surface 35A that is sloped downwardly and to the left in FIG. 3. The flow regulator conduit 30 can further comprise a second baffle 43 that is positioned below the first baffle 41 and which defines a surface 35B that is sloped downwardly and to the right. The second end portion 33 can define an outlet opening 45, and can be in fluid communication with an outlet conduit 76 that leads out of the sealed enclosure 40. The flow regulator conduit 30 can include one sloped interior surface, two sloped interior surfaces, three sloped interior surfaces, or more depending on the specified resolution.

As noted above, the flow regulator conduit 30 can be hung or suspended from a load cell 32, which can be mounted to the sealed enclosure 40, for example.

Returning to FIG. 1, the vibratory feeder 34 can be mounted on a support 78 within the sealed enclosure 40. The vibratory motor 36 can be isolated from the support 78 by shock-absorbing members 80. The vibratory motor 36 can be coupled to the pan 22 by the linkage 38, which can include a plurality of elastic spring members 82 coupled at different mounting points on the frame of the agitator system 34. The spring members 82 can be coupled directly to the pan 22, or they can be coupled to a carrier plate 84 which is coupled to the pan 22.

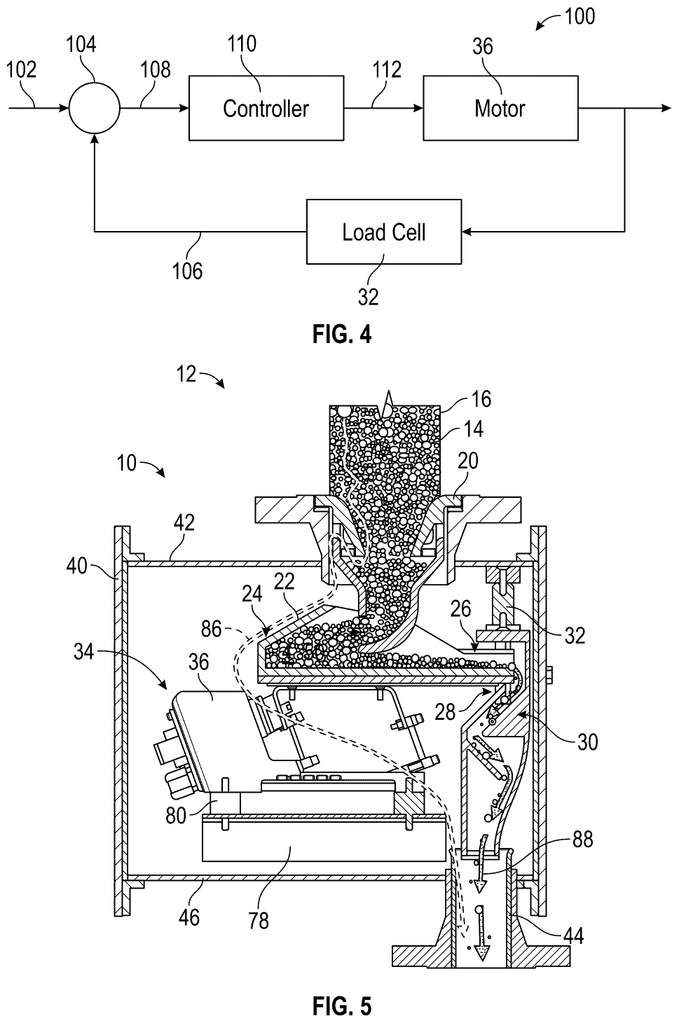

FIG. 4 illustrates a schematic block diagram of a feedback control system 100 that can be used to control the various components of the flow control system 10. An initial mass flow rate command 102 (e.g., a mass flow rate set point) can be provided to a summing junction 104, where the initial mass flow rate command 102 can be combined (e.g., added to or subtracted from) a signal 106 (e.g., data) from the load cell 32 indicative of a measured mass flow rate through the flow control system 10. The resulting mass flow rate error signal 108 can be provided to a controller 110, which can apply any one or more of proportional, integral, and/or derivative (PID) control, and/or various signal filters, to the error signal and can transmit a vibration amplitude and/or frequency command (or a speed command) signal 112 to the vibratory motor 36. The vibratory motor 36 can vibrate the pan 22 according to the vibration amplitude and/or frequency command signal 112 to propel and/or induce motion of the polysilicon granules across the pan. The load cell 32 can determine an updated signal indicative of the mass flow rate of granules flowing through the system (e.g., through the flow regulator conduit 30) and can transmit the updated signal to the summing junction 104. The control system 100 can thus control the mass flow rate of granular material through the flow control system by varying the amplitude, frequency, and/or speed of the vibratory motor based at least in part on the load cell signal 106 to arrive at and/or maintain a specified mass flow rate.

In operation, granular material such as polysilicon 14 can flow through the flow control system 10 along the flow path shown in FIG. 5. Granular polysilicon 14 can be received in the annealer 16, such as from a fluidized bed reactor or other polysilicon source. The polysilicon granules 14 can flow through the annealer 16, where they can be heated by the heaters 18 (FIG. 1). Flow through the annealer 16 can be “plug flow,” in which polysilicon granules 14 are introduced into the annealer and flow out of the annealer through the flow control system 10 continuously, and all or substantially all granules in a given cross section of the annealer have the same or substantially the same velocity and direction of motion. The mass flow rate of granular polysilicon 14 through the annealer 16 can be controlled by the flow control system 10.

The polysilicon granules 14 can exit the annealer 16 into the inlet 48 of the discharge head 20. The polysilicon granules 14 can flow through the nozzle 54 and into the chamber 58, where the granules can form an angle of repose. The vent passages 64 can be clear of (e.g., spaced apart from) the polysilicon granules in the chamber 58 and gas (e.g., a purge gas such as argon, hydrogen, etc.) entrained in the polysilicon granule flow can be vented from the chamber through the vent passages. This can prevent pressure from building up inside the discharge head 20 and forcing granules out through the outlet 50. A representative flow path of gases entrained in the polysilicon granules 14 is illustrated by dashed line 86. As illustrated in FIG. 5, gases exiting the polysilicon bulk material can flow through the vent passages 64 into the sealed enclosure 40, and can flow out through the outlet conduit 44.

The polysilicon granules 14 can flow through the chute 62 and can be discharged into the pan 22 through the outlet 50. Because the outlet 50 of the discharge head 20 is oriented to the side at an angle to the axis 49, the polysilicon granules can flow into the pan 22 and advantageously the pan 22 need not support the weight of the column of granules in the discharge head 20 and the annealer 16 above. The weight of the discharge head 20, the annealer 16, and the column of polysilicon granules in those components can instead be supported by the support structure 21 and/or other supports outside of the sealed enclosure 40.

The polysilicon granules 14 can be received from the discharge head 20 into the cavity 72 of the pan 22, where they can form an angle of repose. The vibratory feeder 34 can vibrate the pan 22, causing granular silicon particles to flow across the pan (e.g., in a thin layer or a monolayer) to the second end portion 26 where they can drop from the edge 74 into the flow regulator conduit 30. The polysilicon granules 14 can drop from the edge 74 to the first sloped surface 35A, from which they can drop to the second sloped surface 35B, and from the second sloped surface 35B to the wall of the second end portion 33 and then through the outlet 45 into the outlet conduit 76. The granules can thus “cascade” through the flow regulator 30 in the manner indicated by arrows 88, and can contact, roll along, and/or rebound from the interior of the flow regulator conduit at multiple locations between the inlet and the outlet. The sloped surfaces 35A and 35B, along with locations where the polysilicon granules contact the interior walls of the flow regulator conduit 30, can increase the residence time of the polysilicon granules in the flow regulator conduit and increase the overall mass of polysilicon granules in the flow regulator conduit as granules roll/drop from one surface to the next. The load cell 32 can record the weight of the flow regulator conduit 30 and the polysilicon granules contained within it, and can transmit this information to the controller 110, which can control the speed of the vibratory motor 36 as described above. The increased residence time of polysilicon granules 14 in the flow regulator conduit 30 as they cascade through the flow regulator conduit can have the effect of increasing the overall mass of the flow regulator conduit as detected by the load cell 32. This can facilitate accurate determination and control of relatively small mass flow rates through the flow control system and the annealer.

In other examples, the flow regulator conduit 30 can be supported on one or more load cells positioned below the flow regulator conduit instead of, or in addition to, being suspended from the load cell 32.

In examples in which the particulate bulk material is polysilicon, surfaces in contact with the polysilicon along the flow path through the flow control system can be coated with and/or made of silicon (Si), silicon carbide (SiC), or other non-contaminating materials. Thus, the components of the flow control system 10 and the annealer 16 can be made from, or can be sheathed in, silicon, silicon carbide, or another non-contaminating material. The surfaces in contact with the polysilicon can thus comprise material(s) configured to maintain the polysilicon at a purity of one part per million to one part per trillion.

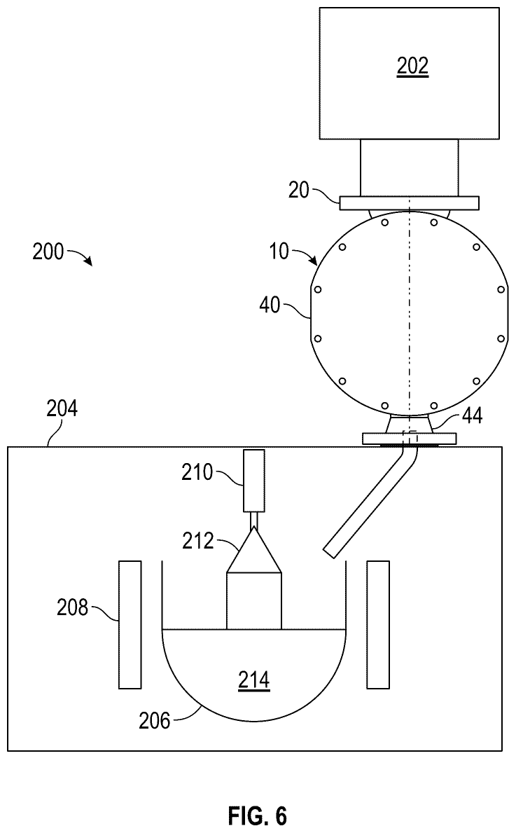

The flow control system examples described herein can be applicable to other systems and processes where accurate flow rate control of polysilicon is desirable. For example, FIG. 6 illustrates an example of a crystal growing system 200 including a polysilicon supply 202 (e.g., a container or other vessel) in fluid communication with a flow control system 10. The flow control system 10 is in fluid communication with a process chamber 204 including, for example, a crucible 206, heat sources 208, and an apparatus 210 for pulling a silicon ingot 212 from a melt 214 contained in the crucible 206. In some examples, polysilicon granules can be dispensed from the supply 202 through the flow control system 10 into the crucible 206 at a specified mass flow rate to replenish the melt during the production of single-crystal silicon ingots.

The flow control systems described herein can also be used in combination with fluidized reactors to control the mass flow rate of polysilicon particles in particle withdrawal and/or particle recycle systems.

The flow control systems described herein can also be adapted for use with other granular or particulate materials such as food products (e.g., beans, seeds, etc.), small machine parts (e.g., ball bearings), gravel, etc.

As noted above, the flow control systems and methods described herein can provide one or more significant advantages over existing systems. For example, the configuration of the discharge head can allow gas entrained in the granular flow to be vented without affecting the flow rate through the outlet (e.g., by avoiding pressure buildup inside the discharge head that would push granules through the outlet). The angled outlet of the discharge head and its position above the pan also means that the pan need only bear the weight of the granules that are in the pan and does not have to support the weight of the granular material column in the granular material supply (e.g., the annealer 16 in FIG. 1). Additionally, the tortuous flow path defined through the flow regulator conduit increases the time required for granular material to flow through the flow regulator conduit, which can increase the total mass of granular material in the flow regulator conduit at a given time and enhance the ability to detect and vary relatively low mass flow rates through the system. The configuration of the discharge head can also allow for particle flow through the flow control system and any associated industrial process to be started and stopped without plugging.

### Example 2: Representative Computing Environment

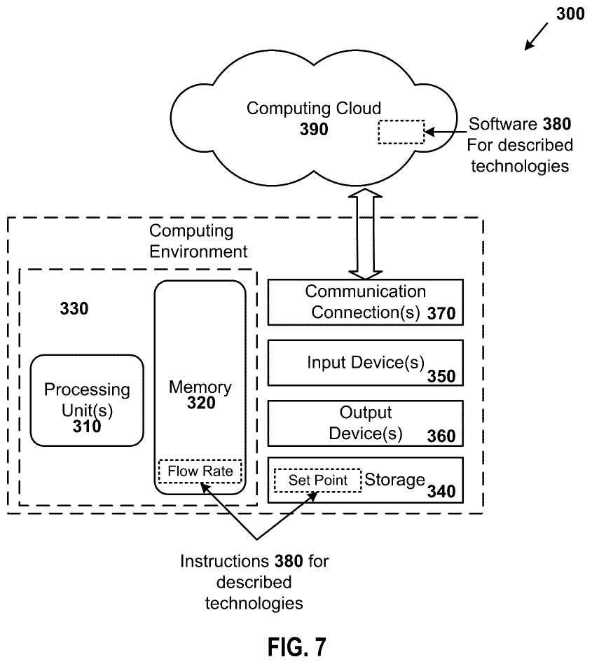

FIG. 7 illustrates a generalized example of a computing environment 300 in which software and control algorithms for the described embodiments can be implemented. For example, software and/or hardware for implementing the various control systems, filters, and PID control methods described herein can be configured similarly to the computing environment 300, and can be a local computing system integrated as part of the flow control system or can be a remote computing system as described herein.

The computing environment 300 is not intended to suggest any limitation as to scope of use or functionality of the technology, as the technology may be implemented in diverse general-purpose or special-purpose computing environments. For example, the disclosed technology may be implemented with other computer system configurations, including programmable automation controllers, programmable logic controllers, application-specific integrated circuits (ASICs), field-programmable gate arrays (FPGAs), handheld devices, multi-processor systems, programmable consumer electronics, network PCs, minicomputers, and the like, any of which can be incorporated into a distributed control system (DCS). The disclosed control methodology may also be practiced in distributed computing environments where tasks are performed by remote processing devices that are linked through a communications network. In a distributed computing environment, program modules may be located in both local and remote memory storage devices.

With reference to FIG. 7, the computing environment 300 includes at least one processing unit 310 and memory 320. In FIG. 7, this most basic configuration 330 is included within a dashed line. The processing unit 310 executes computer-executable instructions and may be a real or a virtual processor. In a multi-processing system, multiple processing units execute computer-executable instructions to increase processing power and as such, multiple processors can be running simultaneously. The memory 320 may be volatile memory (e.g., registers, cache, RAM), non-volatile memory (e.g., ROM, EEPROM, flash memory, etc.), or some combination of the two. The memory 320 stores software 380 that can, for example, implement the technologies described herein. A computing environment may have additional features. For example, the computing environment 300 includes storage 340, one or more input devices 350, one or more output devices 360, and one or more communication connections 370. An interconnection mechanism (not shown) such as a bus, a controller, or a network, interconnects the components of the computing environment 300. Typically, operating system software (not shown) provides an operating environment for other software executing in the computing environment 300, and coordinates activities of the components of the computing environment 300.

The storage 340 may be removable or non-removable, and includes non-volatile solid state memory, magnetic disks, or any other medium which can be used to store information and that can be accessed within the computing environment 300. The storage 340 stores instructions for the software 380, plugin data, and messages, which can be used to implement technologies described herein.

The input device(s) 350 may be, for example, an accelerometer, a position sensor such as an optical time-of-flight sensor, a temperature sensor, a position encoder, or a touch input device such as a keyboard, keypad, mouse, touch screen display, pen, or trackball, a voice input device, a scanning device, or another device, that provides input to the computing environment 300. The output device(s) 360 may be a wired or wireless signal transmitter, a display, or another device that provides output from the computing environment 300.

The communication connection(s) 370 enable communication over a communication medium (e.g., a connecting network) to devices or computing entities. The communication medium conveys information such as control signals, computer-executable instructions, sensor inputs or outputs, or other data in a modulated data signal. The communication connection(s) 370 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controlled devices.

Some examples of the disclosed methods can be performed using computer-executable instructions implementing all or a portion of the disclosed technology in a computing cloud 390 or other remote computing system. For example, the disclosed methods can be executed on processing units 310 located in the computing environment 330, or the disclosed methods can be executed on servers located in the computing cloud 390.

Computer-readable media are any available media that can be accessed within a computing environment 300. By way of example, and not limitation, with the computing environment 300, computer-readable media include memory 320 and/or storage 340. As should be readily understood, the term computer-readable storage media includes the media for data storage such as memory 320 and storage 340, and not transmission media such as modulated data signals.

### Example 3: Flow Control System with Flow Regulator Conduit and Lever Arm

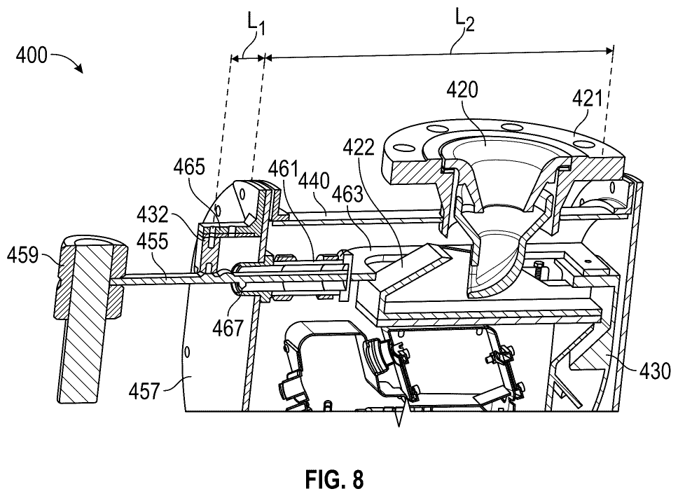

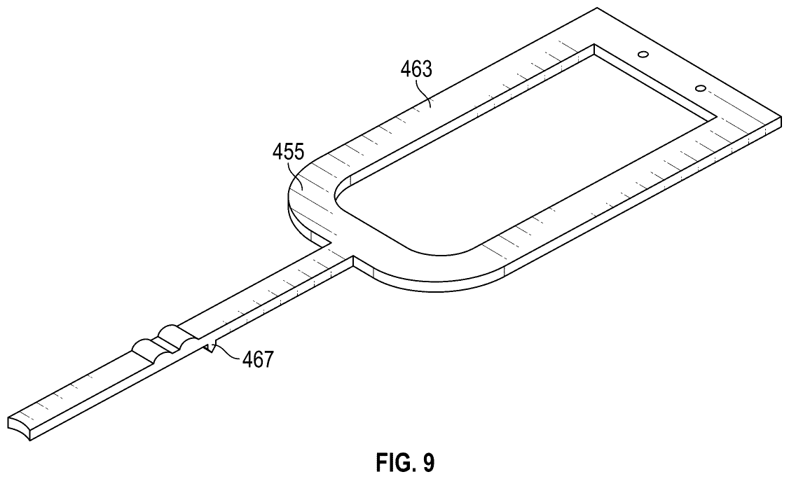

In some examples the weight sensor coupled to the flow regulator conduit can be located inside the sealed enclosure as in FIGS. 1-5, or outside the sealed enclosure. For example, FIG. 8 illustrates another example of a flow control system 400 in which the flow regulator conduit 430 is coupled to the end of a lever arm 455 that extends through the wall 457 of the sealed enclosure 440. In FIG. 8, features similar to the flow control system 10 of FIG. 1 are indicated with similar reference numbers. The lever arm 455 can be coupled to a counterweight 459 positioned outside the sealed enclosure 440. The lever arm 455 can extend into the interior of the sealed enclosure 440 through a sealing member configured as a flexible hose 461. In the illustrated configuration the lever arm 455 can include a ring-shaped portion 463 that extends around the pan 422 and permits the lever arm 455 to pivot and/or deflect up and down within the sealed enclosure around the pan without contacting the pan. The lever arm 455 is shown in isolation and with the complete ring-shaped portion 463 in FIG. 9.

The flow regulator conduit 430 can be suspended from the end of the ring-shaped portion 463 opposite the counterweight 459. The load cell 432 can be coupled between the lever arm 455 and a bracket 465 that is mounted to the exterior of the sealed enclosure 440. The lever arm 455 can pivot about a fulcrum 467. In the illustrated example the fulcrum 467 is located inside the flexible hose 461 and outside of the sealed enclosure 440, although the fulcrum can be positioned inside or outside of the flexible hose 461 and inside or outside of the sealed enclosure 440 depending upon the particular characteristics sought. The lever arm 455 can be shaped and sized to pivot up and down about the fulcrum 467 inside the flexible hose 461 within a selected range of motion. The flexible hose 461 can maintain a seal between the interior of the sealed enclosure 440 and the exterior environment while permitting the lever arm 455 to pivot about the fulcrum 467.

The load cell 432 can be separated from the fulcrum 467 by a first distance L₁ and the flow regulator conduit 430 can be separated from the fulcrum 467 by a second distance L₂. In the illustrated example the second distance L₂ can be greater than the first distance L₁. The ratio of the distances L₁ and L₂ (and the moment arms represented by the distances) can increase or amplify the force applied to the load cell 432 for a given mass flow rate of material through the flow regulator conduit 430.

In operation, the weight of polysilicon granules flowing through the flow regulator conduit 430 can cause the lever arm 455 to pivot about the fulcrum 467 away from its neutral position. The load cell 432 can detect the force applied by the lever arm 455 and can provide this data to the controller 110 as described above. The counterweight 459 can at least partially balance the empty weight of the flow regulator conduit 430 and thus decrease the force applied to the load cell 432 when there is no material flowing through the system. Incorporating a lever arm in the manner shown can increase the sensitivity of the system, and can facilitate detection and fine adjustment of relatively low mass flow rates through the system. Another advantage of this configuration is that the load cell 432 can be isolated from the high temperature environment inside the sealed enclosure 440.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and equivalents of the recited features.

1. A granular material flow control system, comprising:
a granular material supply;
a discharge head in fluid communication with the granular material supply;
a pan positioned beneath the discharge head to receive granular material discharged from the discharge head, the pan comprising a first end portion and a second end portion;
a flow regulator conduit coupled to a weight sensor, the flow regulator conduit having an inlet opening and an outlet opening, the second end portion of the pan being received in the inlet opening of the flow regulator conduit; and
a vibratory feeder coupled to the pan and configured to vibrate the pan to induce granular material in the pan to flow off of an edge of the second end portion into the flow regulator conduit.

2. The granular material flow control system of claim 1, wherein the discharge head comprises an inlet and an outlet and defines a longitudinal axis, and the outlet is oriented at an angle to the longitudinal axis.

3. The granular material flow control system of claim 1, wherein the discharge head comprises vent passages to vent gas from the granular material.

4. The granular material flow control system of claim 3, wherein the discharge head comprises an internal nozzle downstream of the inlet and an internal chamber downstream of the nozzle and upstream of the outlet of the discharge head.

5. The granular material flow control system of claim 4, wherein the vent passages are in fluid communication with the internal chamber.

6. The granular material flow control system of claim 4, wherein a diameter of the internal chamber is greater than a diameter of an outlet of the internal nozzle.

7. The granular material flow control system of claim 1, wherein the first end portion of the pan comprises a bay that is at least partially enclosed.

8. The granular material flow control system of claim 7, wherein the outlet of the discharge head is oriented toward the bay of the pan.

9. The granular material flow control system of claim 1, wherein the flow regulator conduit comprises one or a plurality of angled interior surfaces spaced apart along a longitudinal axis of the conduit.

10. The granular material flow control system of claim 9, wherein the flow regulator conduit comprises a plurality of baffles that define the angled interior surfaces.

11. The granular material flow control system of claim 1, wherein the discharge head is coupled to a support frame, and the support frame supports a weight of the granular material in the discharge head and in the granular material supply.

12. The granular material flow control system of claim 1, wherein the pan, the flow regulator conduit, and the vibratory feeder are mounted inside a sealed enclosure.

13. The granular material flow control system of claim 12, wherein at least the outlet of the discharge head is located inside the sealed enclosure.

14. The granular material flow control system of claim 1, wherein:
the discharge head, the pan, and the flow regulator conduit define a flow path for the granular material;
the granular material is granular polysilicon; and
interior surfaces of the flow path comprise silicon (Si) and/or silicon carbide (SiC).

15. The granular material flow control system of claim 1, wherein:
the granular material is granular polysilicon;
the granular material supply is an annealer; and
the vibratory feeder controls a flow rate of granular polysilicon through the annealer.

16. The granular material flow control system of claim 1, further comprising a controller in communication with the weight sensor to receive a signal from the weight sensor and control an amplitude and/or frequency of the vibratory feeder based at least in part on the signal from the weight sensor.

17. The granular material flow control system of claim 1, wherein the flow regulator conduit is suspended from the weight sensor.

18. The granular material flow control system of claim 1, wherein:
the pan, the flow regulator conduit, and the vibratory feeder are mounted inside a sealed enclosure; and
the weight sensor is outside the sealed enclosure.

19. The granular material flow control system of claim 18, wherein:
the flow regulator conduit is coupled to a lever arm that pivots about a fulcrum as flow increases through the flow regulator conduit; and
the weight sensor is coupled to the lever arm.

20. A method, comprising flowing a granular material through the granular material flow control system of claim 1.

21. A silicon crystal growing system comprising the granular material flow control system of claim 1.

22. A system, comprising:
a granular material supply;
a discharge head in fluid communication with the granular material supply;
a pan positioned beneath the discharge head to receive granular material discharged from the discharge head, the pan comprising a first end portion and a second end portion;
a flow regulator conduit having an inlet opening and an outlet opening, the second end portion of the pan being received in the inlet opening of the flow regulator conduit;
wherein the discharge head comprises an internal nozzle downstream of the inlet and an internal chamber downstream of the nozzle and upstream of the outlet of the discharge head, and the discharge head further comprises vent passages to vent gas from the granular material, the vent passages being in fluid communication with the internal chamber of the discharge head.

23. A method, comprising
receiving data of a mass flow rate of granular polysilicon flowing through the granular material flow control system of claim 1, wherein the data of the mass flow rate is determined by a load cell coupled to the flow regulator conduit;
determining a mass flow rate error based at least in part on the mass flow rate data and a specified mass flow rate;
determining a vibration amplitude and/or a frequency command based at least in part on the mass flow rate error; and
transmitting the vibration amplitude and/or frequency command to a vibratory motor of the vibratory feeder such that the vibratory motor vibrates the pan at a specified amplitude and frequency to propel granular polysilicon through the granular material flow control system.
